(19) United States
(12) Patent Application Publication
(10) Pub. No.: US 2003/0020591 A1
(43) Pub. Date: Jan. 30, 2003

(54) Electrical device having ptc conductive polymer

(76) Inventors: Soo-An Choi, Sungnam (KR); Jong-Ho Lee, Anyong (KR); Chang-Hee Choi, Seoul (KR); Tae-Sung Kim, Seoul (KR)

Correspondence Address: STAAS & HALSEY LLP, 700 11TH STREET, NW, SUITE 500, WASHINGTON, DC, 20001, US

(21) Appl. No.: 10/239,091

(22) PCT Filed: Mar. 30, 2001
(86) PCT No.: PCT/KR01/00523

(51) Int. Cl. H01C 7/10

(52) U.S. Cl. 338/22 R

(57) ABSTRACT

An electrical device having PTC conductive polymer is made by combining electrodes, in which electroless nickel plating is formed on an electrolytic copper foil, with PTC conductive polymer. The electrodes have electroless-plated nickel layers at both sides of an electrolytic copper foil and the PTC conductive polymer is welded between the electrodes in a sandwich type.

Because the electroless-plated nickel of the electrical device has even thickness, the electrical device gives improved PTC characteristics and good chemical and mechanical binding capacity between the electrodes and the PTC conductive polymer.

### TECHNICAL FIELD

The present invention relates to an electrical device having a positive temperature coefficient (PTC) conductive polymer, and more particularly to an electrical device having PTC conductive polymer, which is made by combining electrodes in which electroless nickel plating is formed on an electrolytic copper foil, with PTC conductive polymer, so ensuring improved PTC characteristics and good chemical and mechanical binding capacity between the electrodes and the PTC conductive polymer.

### BACKGROUND ART

There are many electrical devices having PTC conductive polymer known in the related art. The conductive polymer shows PTC characteristics that conductive fillers are dispersed on organic polymer.

PTC means a characteristic that electrical resistance rapidly increases at a relatively narrow temperature range due to increase of temperature. High molecular substances having PTC characteristics are generally used in a constant-temperature wire, a protection device for blocking over current, a circuit protection element, a heater and so on.

Such conductive polymer is mechanically chemically combined with at least one electrode in an electrical device. And, a metal plate is generally used as the electrode combined with the conductive polymer. Such metal plate acts a role of connecting the conductive polymer to an external electrode and should not deteriorate the PTC characteristics of the conductive polymer. For such a reason, the conductive polymer should have good binding capacity to ensure electrical and mechanical combination with the metal plate.

The binding capacity between the metal plate and the conductive polymer generally has two characteristics: mechanical binding capacity and chemical binding capacity. For improving the mechanical binding capacity, a process of increasing surface roughness of the metal plate is required to restrain separation of the metal plate and the conductive polymer. However, though having same surface roughness, metal plates show significantly different binding capacities to the polymer depending on their kinds, which are originated from difference of chemical binding capacities between the metal and the polymer. In case of most polymers such as natural rubber and polypropylene, the chemical binding capacity increases in order of copper, iron, nickel, aluminum, zinc and so on. Therefore, the metal plate to be combined with polymer might be processed by scaling, surface-treatment using brass or zinc, or adhesive application using silane group.

Meanwhile, the electroplating is a representative method to increase surface roughness of the metal plate for restraining separation of the metal plate and the conductive polymer. Currently, a copper plating foil used in a printed circuit boards (hereinafter, referred to as PCB) and a metal plate used in an electrical device having PTC characteristics are manufactured using such method.

The copper plating foil for the PCB is made to have 10 to 150 μm in thickness, in which a circular nodule is formed on a pyramid-shaped nodule to give a mechanical anchoring effect for the conductive polymer.

To make the PCB, a copper foil is laminated on a base plate and then given heat and pressure thereto. The copper foil should have chemical resistance, such as against an acid, and resistance against discoloration of the board after etching after being attached to the base plate, and is required not to rust after etching. For such reasons, a surface of the copper foil for the PCB may be coated by a layer containing zinc, indium, brass or the like (Japanese Patent Publication No. 51-35711), or use an electrodeposited copper layer having two layers (Japanese Patent Publication No. 53-39376). In some cases, the copper-zinc layer may be formed by electrolyzing one surface of the copper foil in a copper-zinc electrolytic bath containing copper ion, zinc ion, tartar acid and alkali with the cathode and then treating chromate on the cupper foil (U.S. Pat. No. 5,304,428).

Other techniques related to the electrical device with conductive polymer having PTC characteristics are disclosed in U.S. Pat. No. 4,426,633, U.S. Pat. No. 4,689,475, U.S. Pat. No. 4,800,253, U.S. Pat. No. 5,874,885, U.S. Pat. No. 5,234,573, and so on.

However, the conventional electrode made by electrolytic plating or electrodeposition shows uneven thickness, which causes the electrode to be separated from the PTC polymer.

Therefore, inventors of the present invention have endeavored to solve such problems and developed an electrode with even thickness by executing electroless plating to the electrolytic cupper foil used for the PCB.

### DISCLOSURE OF INVENTION

An object of the present invention is to provide an electrical device, which is made by combining metal electrodes, in which electroless nickel plating with even thickness is formed on an electrolytic copper foil, with PTC conductive polymer, so ensuring improved PTC characteristics and good chemical and mechanical binding capacity between the electrodes and the PTC conductive polymer.

To perform the above object, the present invention provides an electrical device having Positive Temperature Coefficient (PTC) conductive polymer, which includes electrodes having electroless-plated nickel layers at both sides of an electrolytic copper foil, and PTC conductive polymer welded between the electrodes, wherein the electroless-plated nickel has even thickness to ensure sufficient binding capacity to the PTC conductive polymer.

Preferably, the electrolytic copper foil has surface roughness between 1 and 20 μm and the electroless-plated nickel layer has a thickness between 0.01 and 10 μm.

### BRIEF DESCRIPTION OF THE DRAWINGS

These and other features, aspects, and advantages of the present invention will become better understood with regard to the following description, appended claims, and accompanying drawings, in which like components are referred to by like reference numerals. In the drawings:

FIG. 1 is a surface photograph of an electrolytic copper foil used in the present invention;

FIG. 2 is a surface photograph of a specimen that the electrolytic copper foil is electroless nickel-plated of 1 μm in thickness;

FIG. 3 shows an electrical device according to the present invention; and

FIG. 4 is a resistance-temperature graph of the electrical devices according to first to third embodiments of the present invention.

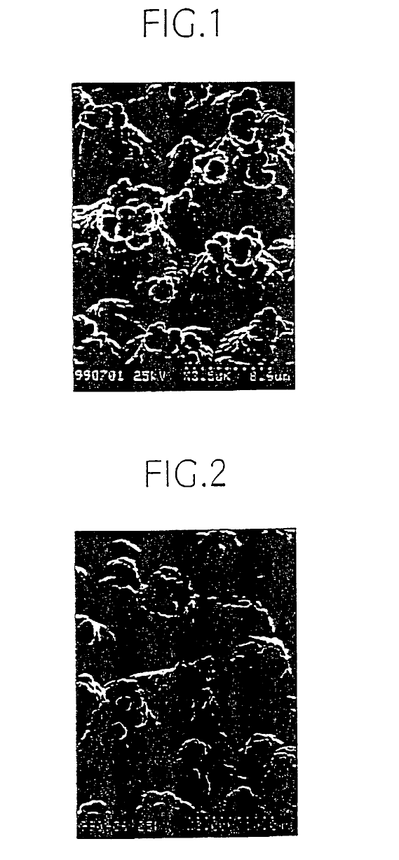

### BEST MODES FOR CARRYING OUT THE INVENTION

Hereinafter, preferred embodiments of the present invention will be described in detail with reference to the accompanying drawings.

The present invention suggests an electrical device including conductive polymer with PTC (Positive Temperature Coefficient) characteristics and electroless-plated metal electrodes. The PTC conductive polymer is welded between the electrodes in a sandwich type.

The conductive polymer with PTC characteristics may be obtained by mixing conductive filler, cross-linking agent, antioxidant, etc. to organic polymer.

At this time, the organic polymer can be one of polyethylene or ethylene-acrylic acid copolymer, ethylene-ethyl acrylate copolymer, ethylene-vinyl acetate copolymer and ethylene-butyl acrylate copolymer. Among them, polyethylene is most preferred.

As the conductive filler, powder nickel, gold dust, powder copper, silvered powder copper, metal-alloy powder, carbon black, carbon powder or carbon graphite can be used. Among them, carbon black is most preferred.

The metal electrode is made by electroless-plating a metal, which has good chemical binding capacity to the PTC conductive polymer, on the electrolytic copper foil having good mechanical binding capacity. A surface roughness R_{z}of the electrolytic copper foil is set to be 1-20 μm through electrolytic plating in its manufacturing process. The electrolytic copper foil can be commercially acquired from LG Industry Co., which is specially used in this invention.

The electrolytic copper foil is electroless-plated with nickel. The electroless nickel-plating procedure includes a degreasing process, a pickling process, an actuating and sensitizing treatment, an electroless nickel-plating process and a rinsing process. A surface photograph of a specimen, which is electroless-plated with nickel of 1 μm in thickness, is shown in FIG. 2. Seeing FIG. 2, it can be easily known that the surface roughness and shape of the specimen have no significant difference.

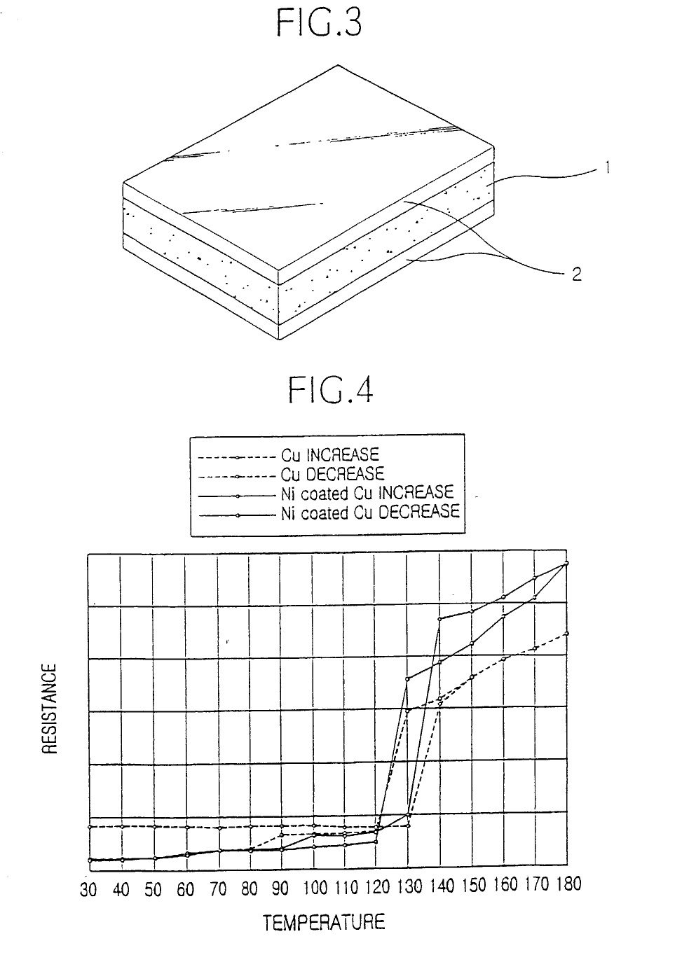

As described above, the metal electrodes 2, in which the nickel is electroless-plated on the copper, are welded at both side of the PTC conductive polymer 1 to make the electrical device. This is well shown in FIG. 3.

Now, embodiments of the present are described below in detail. But, these embodiments are just selected as preferred ones, but not intended to limit the present invention.

Embodiment 1

Polyethylene and carbon black are mixed to make PTC conductive polymer. An electrolytic copper foil having a surface roughness between 5 and 10 μm through electrolytic plating is prepared. Then, an electroless nickel-plating layer of 1 μm in thickness is formed on the electrolytic copper foil through a degreasing process, a pickling process, an actuating and sensitizing treatment, an electroless nickel-plating process and a rinsing process, to make electrodes. The electrodes are welded to both sides of the PTC conductive polymer in a sandwich type, so making the PTC electrical device as shown in FIG. 3.

Embodiment 2

Polyethylene and carbon black are mixed to make PTC conductive polymer. An electrolytic copper foil having a surface roughness of 5 to 10 μm through electrolytic plating is prepared. Then, an electroless nickel-plating layer of 10 μm in thickness is formed on the electrolytic copper foil through a degreasing process, a pickling process, an actuating and sensitizing treatment, an electroless nickel-plating process and a rinsing process, to make electrodes. The electrodes are welded to both sides of the PTC conductive polymer in a sandwich type, so making the PTC electrical device as shown in FIG. 3.

Embodiment 2

An electrical device is prepared in a similar method to the Embodiment 1. However, the actuating and sensitizing treatment is excluded from the electroless-plating procedure, and the electroless nickel-plating process is executed just after the pickling process. And then, chromium is coated on the electroless nickel-plating layer through substitution plating in a chromium bath.

### COMPARATIVE EXAMPLE

Instead of executing electroless nickel-plating on the copper as described in the embodiments 1 to 3, conventional electrodes using only copper foils are welded to the PTC conductive polymer to make an electrical device in a shape of FIG. 3.

Test 1

Resistance-Temperature Characteristics

Resistance changes depending on temperature of the electrical devices according to the embodiments 1 to 3 are shown in FIG. 4. Referring to FIG. 4, it can be easily understood that the electrical devices of the present invention show no significant difference in resistance-temperature characteristics, compared with an electrical device using a conventional electrolytic copper foil.

It means that the electrical device of the present invention not only strengthens binding capacity between the PTC conductive polymer and the electrodes but also maintains its resistance-temperature characteristics as much as the electrical device using the conventional electrolytic copper foil.

Test 2

Humidity Test

Resistances of the electrical devices according to the embodiment 1 and the comparative example are measured before and after the humidity test. Results of this test are described in Table 1 below.

TABLE 1

| | Before humidity test | After humidity test |
|---|---|---|
| Embodiment 1 (Nickel) | 200 mΩ | 190 mΩ |
| Comparative Example | 200 mΩ | less than 10 mΩ |
| (Copper) | | |

As shown in Table 1, the electrical device using copper electrodes of the comparative example shows significant difference in its resistance value before and after the humidity test. But, a resistance value of the electrical device using the electroless nickel plating according to the embodiment 1 does not decrease more than 10 mΩ after the humidity test.

Considering the results of the tests 1 and 2, it may be easily understood that the electrical device of the present invention gives more improved PTC characteristics and better binding capacity between the PTC conductive polymer and the electrodes than the conventional electrical device employing electrolytic plating or electrodeposition.

The electroless plating employed in the present invention has an advantage that it may plate an object having uneven surfaces more uniformly than the electrolytic plating or the electrodeposition.

Therefore, the electrical device of the present invention employing the electrodes, in which nickel is electroless-plated on the electrolytic copper foil, gives the advantages of better mechanical and chemical binding capacity to the PTC conductive polymer and more improved PTC characteristics.

The electrical device having PTC conductive polymer according to the present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An electrical device having Positive Temperature Coefficient (PTC) conductive polymer, comprising:
electrodes having electroless-plated nickel layers at both sides of an electrolytic copper foil; and
PTC conductive polymer welded between the electrodes,
wherein the electroless-plated nickel has even thickness to ensure sufficient binding capacity to the PTC conductive polymer.

2. The electrical device as claimed in claim 1,
wherein the electrolytic copper foil has surface roughness between 1 and 20 μm.

3. The electrical device as claimed in claim 1,
wherein the electroless-plated nickel layer has a thickness between 0.01 and 10 μm.
